(19) United States
(12) Patent Application Publication
(10) Pub. No.: US 2025/0092071 A1
(43) Pub. Date: Mar. 20, 2025

(54) PROCESS FOR PREPARING ISOCYANATOORGANOSILANES

(71) Applicant: Volker Stanjek

(72) Inventor: Volker Stanjek

(73) Assignee: Wacker Chemie AG, Munich (DE)

(21) Appl. No.: 18/710,199

(22) PCT Filed: Jan. 31, 2022
(86) PCT No.: PCT/EP2022/052242

§ 371 Date: May 15, 2024

(51) Int. Cl. C07F 7/18

(52) U.S. Cl. CPC C07F 7/1892

(57) ABSTRACT

A method for preparing isocyanatoalkylalkoxysilanes (S—I) of the general formula (6). Where in a first method step haloalkylalkoxysilane (S—H) of the general formula (7) is reacted with a metal cyanate (MOCN) and an alcohol (A) of the general formula (8), to form a carbamatoalkylalkoxysilane (S—C) of the general formula (9). In a second method step the carbamatoalkylalkoxysilane (S—C) is purified by distillation and in a third method step the isocyanatoalkylalkoxysilane (S—I) is generated from the silane (S—C) by a thermolytic alcohol elimination.

The invention relates to a method for preparing isocyanate-functional organosilanes.

Organosilanes that have both an isocyanate function and a reactive alkoxysilyl group can, by virtue of their isocyanate function, be reacted with almost any hydroxyl-functional polyol.

This capability makes them important starting materials for preparing alkoxysilane-functional polymers. The latter are products that are curable via condensation reactions of their alkoxysilyl groups on contact with atmospheric moisture and are therefore ideal binders that are employed in a multitude of adhesives, sealants, and coatings.

Of particular importance here are alkoxysilane-terminated polypropylene glycols, which are obtainable through reaction of the abovementioned isocyanate-functional alkoxysilanes with long-chain polypropylene glycols. This group of products has meanwhile come to be termed hybrid polymers.

When what are known as α-isocyanatomethyl alkoxysilanes are used in the reaction, i.e. compounds in which the reactive alkoxysilyl group is separated from the isocyanate function by only a methyl group, the corresponding α-alkoxysilane-terminated polymers are obtained. These have the characteristic feature of extremely high reactivity to atmospheric moisture and—unlike most conventional silane-functional polymers—do not require tin catalysts for rapid curing at room temperature. The α-isocyanatomethyl alkoxysilanes are therefore of particular importance.

Various methods for preparing isocyanate-functional alkoxysilanes are known from the prior art. Suitable methods are described in, inter alia, EP 3221324, EP 3546465 or EP 3546468.

The first reaction step in these methods is the reaction of the corresponding amine-functional alkoxysilanes of the formula (1)

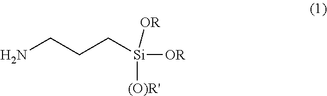

with either a dialkycarbonate (EP 3221324 and EP 3546465) or a mixture of urea and an alcohol (EP 3546468) to form the corresponding carbamate-functional silanes (2).

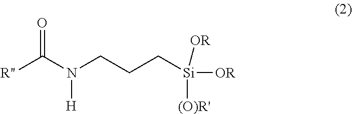

In a second reaction step, the latter then gives rise to the respective isocyanate-functional silane (3) through a thermolytic alcohol elimination.

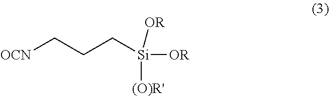

However, a disadvantage of these methods is that the aminoalkylalkoxysilanes needed as starting materials are usually significantly more costly than the corresponding chloroalkylalkoxysilanes. Moreover, only 3-aminopropyl alkoxysilanes are commercially available in sufficiently large amounts, which limits the industrial applicability of these methods to isocyanate-functional silanes that likewise have a propyl spacer between the isocyanate and alkoxysilyl functions. The abovementioned α-isocyanatomethyl alkoxysilanes needed for preparing highly reactive hybrid polymers are currently not obtainable on an industrial scale by these methods on account of the lack of commercial availability of α-aminomethyl alkoxysilanes.

Only the corresponding α-chloromethyl alkoxysilanes are available on an industrial scale. Thus, a method is desirable with which a larger range of different isocyanate-functional silanes, in particular also the abovementioned α-isocyanatomethyl alkoxysilanes, is obtainable from the corresponding chloroalkylsilanes.

The first step in the method, the preparation of carbamate-functional silanes starting from the corresponding chloroalkylsilanes, has already been described, for example in EP 2455385. Here, the chloroalkylalkoxysilanes are heated with potassium cyanate and an alcohol of the formula in a refluxing solvent.

The solvent used here is preferably dimethylformamide. This results in the formation of the corresponding carbamatoalkylalkoxysilanes and potassium chloride as co-product. The solvent is then removed by distillation and the salt filtered off. Preferably, a nonpolar solvent in which the salt is poorly soluble, for example toluene, is added before the filtration step and is removed again by distillation after the filtration step. In the examples in EP 2455385, this method is used both for preparing 3-carbamatopropyl alkoxysilanes, i.e. compounds of the formula (2), and for preparing a-carbamatoethyl alkoxysilanes of the formula (4).

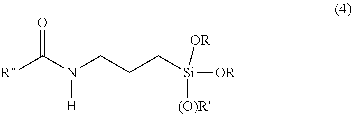

In this case, it is obvious that the carbamatoalkylalkoxysilanes thus prepared can also be processed further to the corresponding isocyanate-functional alkoxysilanes by the known methods for thermolytic alcohol elimination. From the α-carbamatomethyl alkoxysilanes of the formula (4), the corresponding α-isocyanatomethyl alkoxysilanes of the formula (5) would also be obtainable here.

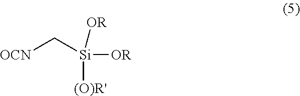

However, a disadvantage of the method described in EP 2455385 for preparing carbamate-functional silanes of the formula (2) or (4) is the long reaction time necessary in order to achieve a high yield. This is all the more detrimental given that the reaction needs to be carried out in a solvent, which occupies a significant part of the reaction volume, thereby further reducing the space-time yield of this step of the method.

In order to keep the scope of the description of the present invention within reasonable limits, only the preferred embodiments of the individual features are set out below.

However, the expert reader should understand this manner of disclosure as meaning that any combination of different levels of preference is therewith also explicitly disclosed and explicitly desired.

It was accordingly an object of the present invention to develop a method for preparing isocyanate-functional organosilanes that no longer has the disadvantages of the prior art.

The invention provides a method for preparing isocyanatoalkylalkoxysilanes (S-I) of the general formula (6),

OCN—R²—Si(R³)₃₋ₓ(OR⁴)ₓ (6)

through a multistep method,
having a 1st method step in which a haloalkylalkoxysilane (S—H) of the general formula (7)

X—R²—Si(R³)₃₋ₓ(OR⁴)ₓ (7)

is reacted with a metal cyanate (MOCN) and an alcohol (A) of the general formula (8),

R¹OH (8)

to form a carbamatoalkylalkoxysilane (S—C) of the general formula (9)

R¹O—CO—NH—R²—Si(R³)₃₋ₓ(OR⁴)ₓ (9)

with the proviso that this reaction is carried out intermittently or entirely in the presence of a component (K) that increases the solubility of anions in the organic reaction mixture and that is present in the reaction mixture in an amount of 0.05% to 5% by weight based on the mass of the total reaction mixture,
a 2nd method step in which the carbamatoalkylalkoxysilane (S—C) is purified by distillation, the distillation being carried out in an evaporation unit (VD) in which the silane (S—C) is vaporized in a layer thickness of not more than 5 cm, at a pressure of not more than 80 mbar, and at temperatures of not more than 200° C.,
and a 3rd method step in which the isocyanatoalkylalkoxysilane (S—I) is generated from the silane (S—C) by a thermolytic alcohol elimination,
where
R¹, R³, and R⁴ are each independently an unsubstituted or halogen-substituted hydrocarbon radical having 1-10 carbon atoms,
R² is a divalent unsubstituted or halogen-substituted hydrocarbon radical having 1-10 carbon atoms, which may be interrupted by non-adjacent oxygen atoms,
X is a halogen atom, and
x is a value of 0, 1, 2, or 3.

Method steps 1 to 3 are carried out one after the other in the specified order. It is of course possible for the method of the invention to also include further method steps in addition to method steps 1 to 3, for example further workup steps of the silane (S—C) that take place between method steps 1 and 2.

The radicals R¹, R³, and R⁴ may be identical or different. Preferably, the radicals R¹ in the alcohol (A) and R⁴ in the haloalkylalkoxysilane (S—H) of the general formula (7) are identical, since it is otherwise possible for the radicals R⁴ to undergo exchange at the silicon atom during step 1 of the method. This would afford a mixture of different silanes (S—C) of the general formula (9) in which the individual silane molecules have different radicals R¹ and different radicals R⁴, which although possible is not usually desired.

Where halogen substituents are present on the radicals R¹, R², R³, and R⁴, they are preferably selected from fluorine and chlorine. However, the radicals R¹, R², R³, and R⁴ are preferably halogen-free.

R³ is preferably a methyl, ethyl, isopropyl or n-propyl radical, with a methyl radical particularly preferred. R⁴ is preferably a methyl, ethyl, isopropyl or n-propyl radical, with a methyl or ethyl radical particularly preferred. R² is preferably a propylene radical or, more preferably, a methylene radical. R¹ preferably represents a methyl, ethyl, isopropyl or n-propyl radical, with a methyl or ethyl radical particularly preferred. The variable x is preferably 2 or 3 and, in the case of the silanes (S—H) of the general formula (7), X is preferably a chlorine atom.

The component (K) used in step 1 of the method is preferably a crown ether and/or what are known as phase-transfer catalysts, with the use of phase-transfer catalysts very particularly preferred.

The component (K) may here consist of just one or of two or more individual compounds. Preferably, all individual compounds of component (K) are crown ethers and/or phase-transfer catalysts, in particular exclusively phase-transfer catalysts.

Crown ethers are cyclic ethers having a schematic construction that is reminiscent of a crown in the sequence of ethyleneoxy units (—CH₂—CH₂—O—) and/or cyclohexane-1,2-diol units. Typical crown ethers consist of 4 ethyleneoxy units ([12]crown-4), 5 ethyleneoxy units ([15]crown-5) or 6 ethyleneoxy units ([18]crown-6). An example of a crown ether that, in addition to ethyleneoxy units, also contains cyclohexane-1,2-diol units is dicyclohexano- [18]crown-6.

Crown ethers form very stable complexes with cations such as potassium or sodium that are soluble in organic media; when these complexes dissolve, the corresponding counteranions by definition dissolve out of the organic matrix too.

Phase-transfer catalysts are salts that have cations having organic radicals and accordingly having good or at least moderate solubility in organic media. In addition, the good solubility of the cation means that an anion by definition goes into solution too. The anion present in the original salt can here be exchanged for other anions.

Typically, phase transfer catalysis describes a chemical process in which a reactant undergoes reaction in an organic phase with an anion that is present as part of a salt in an aqueous phase that is immiscible with the organic phase. The presence here of the phase-transfer catalyst makes it possible for the anion to pass through the phase boundary from the aqueous phase into the organic phase, which is where the actual chemical reaction takes place.

Examples of phase-transfer catalysts are
ammonium salts, such as tetrabutylammonium chloride, methyltributylammonium chloride, methyltrioctylammonium chloride, dimethyldioctadecylammonium chloride, cetyltrimethylammonium chloride, tribenzylmethylammonium chloride, benzyltriethylammonium chloride, alkylbenzyldimethylammonium chloride or tricaprylylmethylammonium chloride, as well as the corresponding ammonium bromides, iodides, and hydroxides, and
phosphonium salts such as tetrabutylphosphonium chloride or hexadecyltributylphosphonium bromide, as well as the corresponding phosphonium bromides, iodides, and hydroxides.

Preferably, the component (K) of the reaction mixture is added in a total amount of from 0.01% to 10% by weight, more preferably in a total amount of from 0.1% to 5% by weight, particularly preferably in a total amount of from 0.3% to 3% by weight, in each case based on the total mass of the reaction mixture. The component (K) may be added before the reaction or while the reaction is in progress, but is preferably added from the start of the reaction.

Particularly preferably, one or more phase-transfer catalysts or/or one or more crown ethers, especially one or more phase-transfer catalysts, is added to the reaction mixture in the preferred, more preferred or particularly preferred total amounts mentioned above.

Preferably, step 1 of the method of the invention is in an anhydrous reaction system, i.e. a system that, in a departure from the usual procedure for a phase-transfer catalysis, does not include an aqueous salt phase.

Metal cyanates (MOCN) used may in principle be the cyanates of any monovalent or divalent metal ions, with alkaline earth metal cyanates and especially alkali metal cyanates preferred. Particular preference is given to using sodium cyanate and especially potassium cyanate.

Use is made of preferably at least 0.8 mol, more preferably at least 0.9 mol, especially at least 1 mol, of cyanate ions, and preferably not more than 2 mol, more preferably not more than 1.5 mol, and especially not more than 1.2 mol, of cyanate ions, per mol of haloalkylalkoxysilane (S—H) of the general formula (7).

The alcohols (A) used are preferably methanol, ethanol, isopropanol or n-propanol, with methanol and ethanol particularly preferred.

Use is made of preferably at least 0.8 mol, more preferably at least 0.9 mol, especially at least 1 mol, of alcohol (A), and preferably not more than 2 mol, more preferably not more than 1.5 mol, and especially not more than 1.2 mol, of alcohol (A), per mol of silane (S—H) of the general formula (7).

Preferably, step 1 of the method of the invention is carried out in the presence of at least one aprotic solvent (L).

The solvent (L) preferably has a boiling point of at least 140° C., more preferably at least 150° C., and preferably not more than 240° C., more preferably not more than 220° C., in each case at 0.1 MPa.

Examples of solvents (L) that may be used are dimethylformamide, dimethyl sulfoxide, N- methylpyrrolidone, N-methylimidazole, sulfolane, diethylformamide, dimethylacetamide, diethylacetamide, acetylacetone, acetoacetic ester, hexamethylphosphoric triamide, nitriles such as acetonitrile or butyronitrile, and also ethers and/or esters having at least two ether or ester groups per molecule. Preferred solvents (L) are dimethylformamide, dimethyl sulfoxide, N-methylpyrrolidone, sulfolane, and diethylformamide, with dimethylformamide particularly preferred.

Preferably, the solvent is used in amounts such that at least 0.1 and not more than 1.5 parts by weight of solvent (L) are used per part by weight of the total amount of the reactants. The total amount of the reactants is composed of the amount of silane (S—H), metal cyanate (MOCN), and alcohol (A). Preferably, the solvent is used in amounts such that not less than 0.2 parts by weight, more preferably not less than 0.3 parts by weight, of solvent (L) are used per part by weight of the total amount of the reactants. Preferably, the solvent is used in amounts such that not more than 1 part by weight, more preferably not more than 0.7 parts by weight, of solvent (L) are used per part by weight of the total amount of the reactants.

In the performance of step 1 of the method of the invention, it is possible for the various reactants, reaction accelerants, solvents, and optionally further auxiliary substances to already be initially charged at the start of the reaction or alternatively be metered in only during the reaction.

In a preferred variant for the performance of step 1 of the method, all solids, including the metal cyanate (MOCN) and component (K), are initially charged in a solvent (L), whereas the haloalkylalkoxysilane (S—H) and the alcohol (A) are, entirely or at least in part, metered in only during the reaction.

Particularly preferably, at least 80% by weight of the haloalkylalkoxysilane (S—H) is metered in only during the reaction. The advantage of this particularly preferred variant lies in the improvement in reaction safety, since the significantly exothermic reaction can be controlled and, if needs be, even stopped through regulating the metered addition of the silane (S—H). Metering in the liquid silane (S—H) is generally much more convenient than metering in the solid metal cyanate (MOCN), which is also in principle conceivable. Regulation of the exothermicity solely via the metered addition of the alcohol (A) is on the other hand not possible, since cyanate (MOCN) and haloalkylalkoxysilane (S—H) can undergo significantly exothermic reactions with the formation of by-products, even in the absence of alcohol (A).

Preference is given to a variant of step 1 of the method of the invention in which the total amount of the alcohol (A) to be used is split such that at least 5%, and more preferably at least 8%, of the total amount of alcohol is already initially charged in the reaction mixture before the start of the reaction and preferably at least 50%, and more preferably at least 70%, of the total amount of alcohol is added to the reaction mixture only during the reaction.

In a particularly preferred variant of step 1 of the method, the amount of the alcohol (A) initially charged and the rate at which the remaining amount of the alcohol (A) is metered in are controlled via the boiling temperature of the reaction mixture. Preferably, alcohol is initially charged in such an amount that the reaction mixture has a boiling point of >110° C., and more preferably >120° C., before the start of metered addition of the alcohol. The upper limit of the boiling point is preferably at least 5° C., more preferably at least 10° C., below the boiling point of the solvent (L).

During step 1 of the method of the invention, the alcohol (A) is preferably metered in at such a rate that the reaction mixture has a boiling point of >110° C., and more preferably >120° C., throughout the reaction time. The upper limit of the boiling point is throughout the reaction time preferably at least 5° C., more preferably at least 10° C., below the boiling point of the solvent (L).

Step 1 of the method of the invention is preferably carried out under reflux.

The described preferred procedure, in which the metered addition of the alcohol during step of the method of the invention is controlled controlled by the reaction temperature, is based on the surprising discovery that it is possible in this way to combine a high reaction rate with a high yield. Thus, metering in the alcohol (A) at an overly rapid rate at which the boiling temperature of the reaction mixture falls below the preferred or particularly preferred limits results in significant slowing of the reaction. Conversely, an overly high temperature or not carrying out the reaction under reflux results in increased formation of oligomeric and/or polymeric impurities.

At the same time, controlling the metering rate of the alcohol (A) via the reflux temperature of the reaction mixture provides an easily implementable option for a person skilled in the art to maintain the alcohol concentration in the reaction mixture within an optimal range throughout the reaction, so as to achieve the best possible results in respect of both reaction rate and yield.

It is optionally possible to use further reaction accelerants during the reaction. A preferred example is the addition of a metal iodide, preferably of an alkali metal iodide, and more preferably of potassium iodide.

Use is made of preferably at least 0.01 parts by weight, more preferably at least 0.1 parts by weight, especially at least 0.5 parts by weight, of metal iodide, and preferably not more than 5 parts by weight, more preferably not more than 3 parts by weight, and especially not more than 2 parts by weight, of metal iodide, per 100 parts by weight of metal cyanate.

The solids can be easily removed at the end of step 1 of the method, this being preferably accomplished by filtration.

Preferably, at least 70%, and more preferably at least 85%, of the solvent (L) is removed by distillation prior to removal of the metal halides formed as by-products and of any residual metal cyanate still present.

In a particularly preferred variant of the method of the invention, the removal of solids, which is accomplished in particular by filtering off the metal salts, is preceded by the addition to the reaction mixture of at least one solvent (L1) that has a dipole moment lower than that of the solvent (L). If the solvent (L1) has a higher boiling point than the solvent (L), the addition of the solvent (L1) can take place before or after the removal by distillation of the solvent (L) in accordance with the invention. However, irrespective of the respective boiling points of the solvents (L) and (L1), the at least one solvent (L1) is preferably added only after the solvent (L) has been removed by distillation.

Preference is given to adding to the reaction mixture, after the removal by distillation of the solvent (L) in accordance with the invention, at least 0.3, especially at least 0.5, parts by weight, and not more than 3, especially not more than 1.5, parts by weight of one or more solvents (L1) per previously removed part by weight of solvent (L).

After the filtration, the filter cake is preferably washed with the same solvent (L1) that had been added to the reaction mixture after removal of the solvent (L). Preferably, the filtrates are then combined and the solvent (L1) removed by distillation.

Preferred solvents (L1) are aromatic and/or aliphatic hydrocarbons (for example the various stereoisomers of pentane, hexane, heptane, octane, etc., cyclopentane, cyclohexane, methylcyclohexane, cycloheptane, etc., benzene, toluene, the various xylene types, etc.), substituted aromatics (for example chlorobenzene), heterocyclic aromatics (for example pyridine, furan, etc.), ethers (for example diethyl ether, methyl t-butyl ether, tetrahydrofuran, dibutyl ether, anisole, etc.), esters (for example ethyl acetate, methyl acetate, butyl acetate, alkyl benzoates, dialkyl maleates, dialkyl phthalates, etc.), ketones (for example acetone, butanone, etc.) or alcohols (for example t-butanol). Particular preference is given to aromatic and/or aliphatic hydrocarbons, for example the various cyclic or non-cyclic pentane, hexane, heptane or octane isomers, and also toluene or xylene.

The preferred use of a second solvent (L1) allows the filterability of the suspension formed in step 1 of the method of the invention to be significantly improved. In addition, the amount of salt remaining in the filtrate in dissolved form is significantly reduced, which is advantageous in the subsequent step 2 of the method, since less salt, or ideally no more salt at all, is able to precipitate in the bottoms during the distillation according to the invention.

The evaporator unit (VD) used in step 2 of the method of the invention may be any evaporator unit known to date, for example a thin-film, falling-film or short-path evaporator, with preference given to the three mentioned evaporator types.

In step 2 of the method of the invention, the preferred layer thickness of the reaction mixture, preferably in the form of a liquid film in the evaporator unit (VD), is preferably not more than 2 cm, more preferably not more than 1 cm, especially not more than 0.5 cm, most preferably not more than 0.3 cm.

Preferably, step 2 of the method of the invention is carried out in the evaporator unit (VD) at a pressure of not more than 20 mbar, more preferably not more than 10 mbar, especially not more than 5 mbar.

Preferably, step 2 of the method of the invention is carried out in the evaporator unit (VD) at a temperature of not more than 180° C., more preferably not more than 160° C., especially not more than 140° C.

Preferably, step 2 of the method of the invention is carried out such that the reaction mixture has an average residence time in the evaporation unit (VD) of not more than 20 minutes, more preferably of not more than 10 minutes, especially preferably not more than 5 minutes.

All steps of the method of the invention are preferably carried out in an atmosphere of inert gas, preferably argon or nitrogen.

Step 2 of the method of the invention is based on multiple discoveries. One such discovery that was foreseeable was that it is not possible to remove the component (K), which increases the solubility of anions in the organic reaction mixture, by a filtration after step 1 of the method. The same applies of course to the anion too, the solubility of which in organic media is improved by the component (K).

However, what was surprising was that the carbamatoalkylalkoxysilane (S—C) that was not liberated from the component (K) and the associated anion is no longer able to undergo thermolytic cleavage to the desired carbamatoalkylalkoxysilane (S—I).

Also surprising was the fact that the carbamatoalkylalkoxysilane (S—C) cannot be separated from the component (K) the associated anion by a conventional distillation. Such a conventional distillation could, for the sake of simplicity, have been carried out directly after distillative removal of the solvent (L1), by lowering the pressure and/or increasing the temperature in the distillation bottoms. However, this was found not to be possible because, under these conditions, large proportions, i.e. typically 30-50%, of the carbamatoalkylalkoxysilane (S—C) produced in the first step of the reaction are converted into various compounds of low volatility, which dramatically reduces the isolable yield of this silane.

After step 2 of the method of the invention, the carbamatoalkylalkoxysilanes (S—C) prepared according to the invention preferably have a purity of >90%, more preferably of >95%, especially >98%.

The thermolytic alcohol elimination from the carbamatoalkylalkoxysilane (S—C) that takes place in step 3 of the method of the invention may be effected in various ways. Preferably, the carbamatoalkylalkoxysilanes (S—C) are heated to high temperatures >200° C., more preferably >250° C., if necessary even >280° C., resulting in the elimination of a molecule of the alcohol from the carbamate function and the formation of the isocyanatoalkylalkoxysilane (S—I).

This cleavage can of course be effected comparatively simply in a flask or boiler, with the more volatile reaction products removed by distillation. However, more elaborate methods, such as those described in EP 3221324 or EP 3546465, are usually more efficient.

Particular preference is given to the methods described in EP 3221324, in which the cleavage of the carbamatoalkylalkoxysilanes takes place continuously in a thin-film or short-path evaporator at a pressure of >100 mbar, preferably >500 mbar, in the presence of a catalyst (K). This method has the advantage that the reaction products vaporize with particular rapidity, which means that undesired further reactions are able to occur only to a minor extent. In addition, the rapid vaporization causes a steady shift in the reaction equilibrium in favor of the products.

The catalyst (K) is preferably admixed with the carbamatoalkylalkoxysilane (S-C) before the start of the reaction. More preferably, the catalyst (K) is liquid or soluble in the carbamatoalkylalkoxysilane (S—C). Preferred catalysts (K) here are all compounds used in polyurethane chemistry for the catalysis of condensation reactions of isocyanates and alcohols. Examples include the organic tin compounds typically used, for example dibutyltin dilaurate, dioctyltin dilaurate, dibutyltin diacetylacetonate, dibutyltin diacetate or dibutyltin dioctoate, etc. It is similarly also possible to use divalent tin catalysts such as tin diacetate or tin dilaurate. In addition, organic bismuth and/or zinc compounds, for example the various catalysts from Borchert such as Borchi Kat 22, Borchi Kat 24 or Borchi Kat 0244, organic titanium compounds such as titanates, for example titanium(IV) isopropoxide or titanium(IV) acetylacetonate, organic iron compounds, for example iron(III) acetylacetonate or iron(II) acetylacetonate, or other metal compounds such as zirconium(IV) acetylacetonate, cobalt(III) acetylacetonate or manganese acetonate may be used.

Combinations of two or more catalysts (K) can of course also be used. Preference is given to using catalysts having little or no volatility, in particular the abovementioned metal complexes, with tin(IV), tin(II), and iron(III) complexes particularly preferred. The catalyst (K′) is preferably used in concentrations of 1-10 000 ppm, with concentrations of 10-5000 ppm or 100-2000 ppm particularly preferred.

In a preferred embodiment of the invention, a flow of an inert gas, for example argon, hydrogen or nitrogen, is passed through this evaporation unit during the vaporization process. Said flow is preferably heated prior to introduction into the evaporation unit, particularly in the industrial process. The hot flow of carrier gas promotes the heating and vaporization of the reaction mixture. The preferred gas is nitrogen.

The vaporized reaction products preferably then undergo fractional condensation, wherein the eliminated alcohol is removed preferably in gaseous form and the isocyanatoalkylalkoxysilane (S—I) and any carbamatoalkylalkoxysilane (S—C) also partially vaporized are condensed together or else optionally separately in succession. The removal of the alcohol prevents the reverse reaction of the isocyanatoalkylalkoxysilane (S—I) that is formed. Preferably, the removal of the alcohol takes place in a condenser or a simple separation column, in which the alcohol is drawn off in gaseous form and silanes (S—I) and (S—C) condensed out together.

The isocyanatoalkylalkoxysilane (S—I) is then preferably purified by distillation, which can take place either continuously or discontinuously, the former being preferred. The carbamatoalkylalkoxysilane (S—C) thereby separated is preferably returned to the thermolytic preparation process.

The method of the invention has the advantage of being suitable for the preparation of all isocyanatoalkylalkoxysilanes (S—I) for which the corresponding haloalkylalkoxysilanes (S—H) are available. This is the case in particular for the α-isocyanatomethyl alkoxysilanes, which are of particular interest on account of their high reactivity.

The method of the invention has the advantage of affording very good yields and of therefore being comparatively cost-effective.

The method of the invention has the advantage that, after step 2 of the method, the carbamatoalkylalkoxysilane (S—C) produced as an intermediate according to the invention contains only minimal by-products that can cause problems in step 3 of the method, for example through the formation of deposits.

The method of the invention has the advantage of being very simple and robust.

All of the above symbols in the above formulas are in each case defined independently of one another. The silicon atom is tetravalent in all formulas.

The examples that follow describe how the present invention may be performed in principle but without limiting said invention to what is disclosed therein.

In the examples that follow, unless otherwise stated in each case, all amounts and percentages are based on weight, all pressures are 0.10 MPa (abs.), and all temperatures are 20° C.

### EXAMPLE 1a

### Procedure According to the Invention for Step 1 of the Method: Synthesis of N-(methyldimethoxysilylmethyl)-O-methylcarbamate

A suspension of 584 g (7.2 mol) of potassium cyanate, 5.8 g of potassium iodide, and 30 g of tetrabutylammonium bromide in 921 g of dimethylformamide and 24 g (0.75 mol) of methanol is heated to 125° C. in a 4000 ml four-necked flask with reflux condenser, precision glass stirrer, and thermometer. A solution of 1067 g (6.9 mol) of 1-chloromethyl-methyldimethoxysilane and 210 g (6.6 mol) of methanol is then metered in. The reaction is carried out under reflux, with the metering rate controlled by the boiling temperature of the reaction mixture such that this temperature is constantly within a very narrow temperature window of between 123° C. and 127° C. A reduction in the addition rate results in a rise in the boiling temperature and vice versa. The metering time is 90 min. At the end of the addition, the mixture is stirred for a further 120 min, the reflux temperature remaining, after an initially slightly upward trend, in the range between 125 and 130° C.

The reactant, 1-chloromethyl-methyldimethoxysilane, is thereafter detectable by gas chromatography only in traces of <0.1% based on the amount of product formed.

The mixture is cooled to approx. 50° C. and a total of 1040 g is distilled off through a Vigreux column of approx. 20 cm in length. During the distillation, the pressure is gradually lowered from an initial 14 mbar to 9 mbar. The bottoms temperature rises from 55° C. to 100° C., whereas the overhead temperature initially remains largely constant within a range of 46-48° C., but rises sharply toward the end of the distillation. At an overhead temperature of 80° C., the distillation is ended. The distillate consists essentially of dimethylformamide, which still contains the excess, unreacted methanol and also a smaller amount (approx. 2%) of the methyltrimethoxysilane formed as a by-product and approx. 5% of the product too. After removal of the low-boiling constituents methanol and methyltrimethoxysilane, this can be readily reused, thereby also returning the product contained in the distillate to the preparation process.

On completion of the distillation, the reaction mixture is cooled to approx. 30° C. 1000 g of toluene is then added and the mixture stirred at room temperature for 30 min. All solids are then filtered off by passage through a pressure suction filter with a Seitz K900 filter at an overpressure of 0.2 bar. The filtration is readily possible and is completed within approx. 20 minutes. The filter cake is washed with two 500 g portions of toluene, washing likewise being completed within approx. 20 minutes. The filtrates are combined.

Lastly, the toluene is removed by distillation at a pressure of approx. 30 mbar and a bottoms temperature that increases from 30 to 70° C. in the course of the distillation. This results in the recovery of approx. 95% of the amount of toluene used, in a purity of >95%. The toluene distilled off can be readily reused.

At the end of distillation, the pressure is lowered to 1 mbar and the bottoms temperature increased to 130° C. for 10 min. The approx. 47 ml of distillate obtained in this operation essentially comprises residual dimethylformamide and toluene that had remained in the reaction mixture until then.

1234 g remains in the distillation bottoms. This crude product is analyzed by ¹H NMR. The product purity can be determined for example by integrating the CH₃O—CO—NH—CH₂—Si(CH₃)(OCH₃)₂ signal and comparing this integral value with the signal integrals of an added internal standard such as trimethyl benzenetricarboxylate. The crude product analyzed by this method has a purity of 92.8%. The crude product is a light yellow, clear liquid.

### EXAMPLE 1b

### Procedure According to the Invention for Step 1 of the Method: Synthesis of N-(methyldimethoxysilylmethyl)-O-methylcarbamate

The procedure is per example 1a, but replacing the 30 g of tetrabutylammonium bromide with exactly the same amount by weight of tetrabutylammonium chloride. All other method parameters remain unchanged.

In other words, the reaction is here too carried out under reflux, with the metering rate controlled by the boiling temperature of the reaction mixture, such that this temperature is constantly within the same temperature window of 123° C. to 127° C. The metering time is 105 min. At the end of the addition, the mixture is stirred under reflux at 125-130° C. for a further 120 min.

The workup of the reaction mixture is likewise carried out exactly as described in example la. The results are, within the measurement accuracy, identical to those of example 1a.

### EXAMPLE 1c

### Procedure According to the Invention for Step 1 of the Method: Synthesis of N-(methyldimethoxysilylmethyl)-O-methylcarbamate

The procedure is per example 1a, but replacing the 30 g of tetrabutylammonium bromide with exactly the same amount by weight of tetrabutylphosphonium bromide. All other method parameters remain unchanged.

In other words, the reaction is here too carried out under reflux, with the metering rate controlled by the boiling temperature of the reaction mixture, such that this temperature is constantly within the same temperature window of 123° C. to 127° C. The metering time is 95 min. At the end of the addition, in a departure from example 1a, the mixture is stirred under reflux at 125-130° C. for a further 60 min.

The workup of the reaction mixture is likewise carried out exactly as described in example 1a. The results are, within the measurement accuracy, largely identical to those of example 1a, but the purity of the crude product is slightly lower, at approx. 91.9%.

### EXAMPLE 1d

### Procedure According to the Invention for Step 1 of the Method: Synthesis of N-(methyldimethoxysilylmethyl)-O-methylcarbamate

The procedure is per example 1a, but replacing the 30 g of tetrabutylammonium bromide with exactly the same amount by weight of triphenylmethylammonium chloride. All other method parameters remain unchanged.

In other words, the reaction is here too carried out under reflux, with the metering rate controlled by the boiling temperature of the reaction mixture, such that this temperature is constantly within the same temperature window of 123° C. to 127° C. The metering time is 140 min. At the end of the addition, the mixture is stirred under reflux at 125-130° C. for a further 120 min.

The workup of the reaction mixture is likewise carried out exactly as described in example 1a. The results are, within the measurement accuracy, largely identical to those of example 1a, but the purity of the crude product is slightly lower, at approx. 91.1%.

### COMPARATIVE EXAMPLE V1a

### Noninventive Procedure for Step 1 of the Method: Synthesis of N-(methyldimethoxysilylmethyl)-O-methylcarbamate

The procedure is per example 1a, but omitting without replacement the addition of a phase-transfer catalyst, i.e. the addition of tetrabutylammonium bromide. All other method parameters remain unchanged.

In other words, the reaction is here too carried out under reflux, with the metering rate controlled by the boiling temperature of the reaction mixture, such that this temperature is constantly within the same temperature window of 123° C. to 127° C. The metering time is 350 min. At the end of the addition, the mixture is stirred under reflux ° C. for a further 120 min, whereupon the temperature rises from an initial 123° C. to 125° C.

The workup of the reaction mixture is likewise carried out exactly as described in example 1a. The purity of the end product is 85.7%, which is lower than in example 1a. All other results are comparable.

### COMPARATIVE EXAMPLE V1b

### Noninventive Procedure for Step 1 of the Method: Synthesis of N-(methyldimethoxysilylmethyl)-O-methylcarbamate

The procedure is per example V1, but with only 10 g of methanol, instead of 24 g of methanol, initially charged at the start of the reaction.

Thereafter this reaction is likewise carried out under reflux, with the metering rate controlled by the boiling temperature of the reaction mixture. However, this is metered in at a rate such that this temperature is constantly within a temperature window of 135 to 140° C. The metering time is 230 min. At the end of the addition, the mixture is stirred under reflux at 130° C. for a further 120 min.

The workup of the reaction mixture is likewise carried out exactly as described in example 1a. However, the purity of the end product is 81%, which is significantly lower than in the preceding examples.

### EXAMPLE 2a

### Procedure According to the Invention for Step 2 of the Method: Distillation of N-(methyldimethoxysilylmethyl)-O-methylcarbamate via a Short-Path Evaporator

400 g of N-(methyldimethoxysilylmethyl)-O-methylcarbamate prepared according to example 1 is passed through a short-path evaporator with Teflon wipers and an internal cooling loop at a metering rate of 720 ml/h. The short-path evaporator has a diameter of 8 cm and a length of 28 cm. The wall temperature of the short-path evaporator is 125° C. and the applied pressure is 1 mbar. The bottoms is a yellow liquid that becomes very viscous at room temperature, but does not contain any precipitated solids. The end product is collected in the distillate outflow of the short-path evaporator. It is a light yellow liquid. The distillate yield is 368 g (92.0%).

The purity of the product is determined by GC and is 96.3%, the most important impurities being dimethylformamide (2.0%), methyltrimethoxysilane (0.2%), methanol (0.3%), and toluene (0.2%). GC-MS is employed to specifically look for possible decomposition products of the phase-transfer catalyst. This detected 0.003% of tributylamine. The bromine content is determined by elemental analysis. This is 2 ppm.

### EXAMPLE 2b

Procedure according to the invention for step 2 of the method: Distillation of N- (methyldimethoxysilylmethyl)-O-methylcarbamate via a short-path evaporator 400 g of N-(methyldimethoxysilylmethyl)-O-methylcarbamate prepared according to example 1b is also distilled as described in example 2a. The wall temperature of the short-path evaporator is again 125° C. and the applied pressure 1 mbar. The bottoms is a yellow liquid that becomes very viscous at room temperature, but does not contain any precipitated solids. The end product is collected in the distillate outflow of the short-path evaporator. It is a colorless liquid. The yield is 370 g (92.5%).

The purity of the product is 96.1%, the most important impurities being dimethylformamide (1.9%), methyltrimethoxysilane (0.1%), methanol (0.1%), and toluene (0.2%).

### EXAMPLE 2c

### Procedure According to the Invention for Step 2 of the Method: Distillation of N-(methyldimethoxysilylmethyl)-O-methylcarbamate via a Short-Path Evaporator

400 g of N-(methyldimethoxysilylmethyl)-O-methylcarbamate prepared according to example 1c is also distilled as described in example 2a. The wall temperature of the short-path evaporator is however only 100° C. and the applied pressure 1 mbar. The bottoms is a yellow liquid that contains no solids and maintains low viscosity even when cooled to room temperature. The end product is collected in the distillate outflow of the short-path evaporator. It is a colorless liquid. The yield is 329 g (82.3%).

The purity of the product is 97.2%, the most important impurities being dimethylformamide (1.8%), methyltrimethoxysilane (0.2%), methanol (0.1%), and toluene (0.2%). The phosphorus content was determined by elemental analysis. This is 130 ppm.

### COMPARATIVE EXAMPLE V2a

### Procedure for Step 2 of the Method: Distillation of Noninventively Prepared N-(methyldimethoxysilylmethyl)-O-methylcarbamate via a Short-Path Evaporator

400 g of N-(methyldimethoxysilylmethyl)-O-methylcarbamate prepared according to comparative example V1a is also distilled as described in example 2a. The wall temperature of the short-path evaporator is 125° C. and the applied pressure 1 mbar. The bottoms is a yellow liquid from which a small amount of a crystalline solid precipitates upon cooling. The end product is collected in the distillate outflow of the short-path evaporator. It is a colorless liquid. The yield is 343 g (85.8%) and is thus significantly lower than in the directly comparable example 2a.

The purity of the product is 96.2%, the most important impurities being dimethylformamide (2.1%), methyltrimethoxysilane (0.1%), methanol (0.1%), and toluene (0.2%).

### COMPARATIVE EXAMPLE V2b

### Noninventive Procedure for Step 2 of the Method: Distillation of N-(methyldimethoxysilylmethyl)-O-methylcarbamate Using a Conventional Distillation Apparatus

400 g of N-(methyldimethoxysilylmethyl)-O-methylcarbamate prepared according to example 1a is distilled at a pressure of 1 mbar in a 1 l flask with Claisen head, but no column. This is accompanied by an initially gradual rise in the bottoms temperature from 115° C. to 145° C. and then an abrupt rise to 180° C. after about two-thirds of the flask contents have distilled over. The overhead temperature is at first largely constant at 100° C., then gradually begins to rise to 103° C. after distillation of about half the flask contents. During the final abrupt rise in the bottoms temperature, the overhead temperature initially rises to 110° C. until almost no more distillate passes over, after which the overhead temperature begins to fall. The distillation is then ended. The distillate yield is approx. 295 g. An analysis of the bottoms using ¹H NMR shows the near-absence in the bottoms (<1%) of N-(methyldimethoxysilylmethyl)-O-methylcarbamate.

### EXAMPLE 3a

### Procedure According to the Invention for Step 3 of the Method: Synthesis of (α-isocyanatomethyl)methyldimethoxysilane

The N-(methyldimethoxysilylmethyl)-O-methylcarbamate is cleaved into (isocyanatomethyl) methyldimethoxysilane and methanol in a thin-film evaporator having a length of 25 cm, an internal diameter of 8 cm, and a wall temperature of 300° C.

300 g of the N-(3-trimethoxysilylpropyl)-O-methylcarbamate distilled in examples 2a is mixed with 0.21 g of dioctyltin dilaurate. The mixture is metered in at a rate of 165 ml/h at the top end of the thin-film evaporator. A nitrogen flow of 65 l/h is passed from the bottom to the top, i.e. against the direction of flow of the reaction mixture. Under these conditions, the bottoms outflow amounts to approx. 10% of the amount of silane metered in.

The vaporized product mixture is passed together with the nitrogen flow through a Vigreux column that is 10 cm in length and insulated with an aluminum foil cladding, with the liquid column return fed back into the thin-film evaporator. The overhead temperature of the Vigreux column is constant within a temperature window of 203-250° C. The mixture of reactant silane and product silane is selectively condensed from this gas flow at a temperature of 54° C. by means of a conventional glass condenser. In a second condensation step, the methanol is then condensed out at a temperature of 0° C. prior to passage of the nitrogen flow through a cooling trap into the air-extraction system of the fume hood in which the entire system is situated.

238 g of condensed silane mixture is obtained. The colorless liquid is analyzed by ¹H NMR and gas chromatography. It contains 33.5% of (α-isocyanatomethyl) methyldimethoxysilane and 63.9% of N-(3-trimethoxysilylpropyl)-O-methylcarbamate.

### EXAMPLE 3b

### Procedure According to the Invention for Step 3 of the Method: Synthesis of (α-isocyanatomethyl)methyldimethoxysilane

300 g of the N-(3-trimethoxysilylpropyl)-O-methylcarbamate distilled in examples 2b is reacted using the exact same method described in example 3a.

234 g of condensed silane mixture is obtained. The colorless liquid is analyzed by ¹H NMR and gas chromatography. It contains 34.5% of (α-isocyanatomethyl) methyldimethoxysilane and 63.1% of N-(3-trimethoxysilylpropyl)-O-methylcarbamate.

### EXAMPLE 3c

### Procedure According to the Invention for Step 3 of the Method: Synthesis of (α-isocyanatomethyl)methyldimethoxysilane

300 g of the N-(3-trimethoxysilylpropyl)-O-methylcarbamate distilled in examples 2c is reacted using the exact same method described in example 3a.

233 g of condensed silane mixture is obtained. The colorless liquid is analyzed by ¹H NMR and gas chromatography. It contains 34.1% of (α-isocyanatomethyl) methyldimethoxysilane and 63.3% of N-(3-trimethoxysilylpropyl)-O-methylcarbamate.

### COMPARATIVE EXAMPLE V3a

### Procedure for Step 3 of the Method: Synthesis of (α-isocyanatomethyl)methyldimethoxysilane from Noninventively Distilled N-(methyldimethoxysilylmethyl)-O-methylcarbamate

The same apparatus and same reaction conditions were used as in example 3a, but using an N-(3-trimethoxysilylpropyl)-O-methylcarbamate that had been prepared according to example 1a, but not subsequently passed through a thin-film evaporator in accordance with the invention.

300 g of this material is mixed with 0.21 g of dioctyltin dilaurate. As in example 3a, this mixture is metered in at a rate of 165 ml/h at the top end of the thin-film evaporator. A nitrogen flow of 65 l/h is passed from the bottom to the top, i.e. against the direction of flow of the reaction mixture. After just a metering time of approx. 15 min, a distinct increase in operating noises shows that the thin-film evaporator is starting to run noticeably less smoothly. After 30 min, the wiper basket of the thin-film evaporator ultimately becomes stuck and cannot be turned by the drive or by hand. The reaction is then aborted. The small amount of product obtained (approx. 50 g) is not analyzed in more detail.

1-10. (canceled)

11. A method for preparing isocyanatoalkylalkoxysilanes (S—I), comprising:
wherein the isocyanatoalkylalkoxysilanes (S—I) has a general formula (6),
OCN—R²—Si(R³)₃₋ₓ(OR⁴)ₓ (6)
wherein through a multistep method having a 1st method step in which a haloalkylalkoxysilane (S—H) of the general formula (7)
X—R²—Si(R³)₃₋ₓ(OR⁴)ₓ (7)
is reacted with a metal cyanate (MOCN) and an alcohol (A) of the general formula (8),
R¹OH (8)
to form a carbamatoalkylalkoxysilane (S—C) of the general formula (9)
R¹O—CO—NH—R²—Si(R³)₃₋ₓ(OR⁴)ₓ (9);
with the reaction is carried out intermittently or entirely in the presence of a component (K) that increases the solubility of anions in the organic reaction mixture and that is present in the reaction mixture in an amount of 0.05% to 5% by weight based on the mass of the total reaction mixture;
wherein in a 2nd method step in which the carbamatoalkylalkoxysilane (S—C) is purified by distillation, wherein the distillation being carried out in an evaporator unit (VD) in which the silane (S—C) is vaporized in a layer thickness of not more than 5 cm, at a pressure of not more than 80 mbar, and at temperatures of not more than 200° C.;
wherein in a 3rd method step in which the isocyanatoalkylalkoxysilane (S—I) is generated from the silane (S—C) by a thermolytic alcohol elimination;
wherein R¹, R³, and R⁴ are each independently an unsubstituted or halogen-substituted hydrocarbon radical having 1-10 carbon atoms;
wherein R² is a divalent unsubstituted or halogen-substituted hydrocarbon radical having 1-10 carbon atoms, which may be interrupted by non-adjacent oxygen atoms;
wherein X is a halogen atom; and
wherein x is a value of 2 or 3.

12. The method of claim 11, wherein the method is carried out in the presence of at least one aprotic solvent (L).

13. The method of claim 11, wherein in the 1st method step all solids, including the metal cyanate (MOCN) and component (K), are initially charged in the solvent (L) and the haloalkylalkoxysilane (S—H) and the alcohol (A) are, entirely or in part, metered in during the reaction.

14. The method of claim 11, wherein in the 1st method step at least 80% by weight of the haloalkylalkoxysilane (S—H) is metered in only during the reaction.

15. The method of claim 11, wherein in the 1st method step the total amount of the alcohol (A) to be used is split such that at least 5% of the total amount of alcohol is already initially charged in the reaction mixture before the start of the reaction and preferably at least 50% of the total amount of alcohol is added to the reaction mixture only during the reaction.

16. The method of claim 11, wherein in the 1st method step the amount of the alcohol (A) initially charged and the rate at which the remaining amount of the alcohol (A) is metered in are controlled via the boiling temperature of the reaction mixture, such that alcohol is initially charged in such an amount that the reaction mixture has a boiling point of >110° C. before the start of metered addition of the alcohol.

17. The method of claim 16, wherein in the 1st method step the upper limit of the boiling point remains at least 5° C. below the boiling point of the solvent (L).

18. The method of claim 16, wherein the 1st method step it is controlled in this manner throughout the reaction time.

19. The method of claim 17, wherein the 1st method step is controlled in this manner throughout the reaction time.

20. The method of claim 11, wherein in the 1st method step at least 0.01 to not more than 5 parts by weight of a metal iodide per 100 parts by weight of metal cyanate (MOCN) are used.
